(19) United States
(12) Patent Application Publication
(10) Pub. No.: US 2005/0134695 A1
(43) Pub. Date: Jun. 23, 2005

(54) Systems and methods for providing remote camera control

(76) Inventor: Sachin Govind Deshpande, Vancouver, WA (US)

Correspondence Address: Michael F. Krieger;Kirton & McConkie, 1800 Eagle Gate Tower, 60 East South Temple, Salt Lake City, UT, 84111, US

(21) Appl. No.: 10/738,475

(22) Filed: Dec. 17, 2003

(51) Int. Cl. H04N 5/232; H04N 7/00; H04N 11/00

(52) U.S. Cl. 348/211.3; 348/211.9; 348/552

(57) ABSTRACT

Systems and methods for allowing any control point of a network to dynamically discover a remote camera control service and to selectively invoke actions to remotely control the camera. In a system that includes a camera or other video input device, the camera is remotely controlled. A variety of actions may be selectively invoked to further control the camera, such as querying the current zoom settings of the remote camera, the setting of the zoom settings for the remote camera, querying the current pan settings of the remote camera, the setting of the pan settings for the remote camera, querying the current tilt settings of the remote camera, the setting of the tilt settings for the remote camera, querying the current brightness settings of the remote camera, the setting of the brightness settings for the remote camera, the querying of the current contrast settings of the remote camera, the setting of the contrast settings for the remote camera, the querying of the current hue settings of the remote camera, the setting of the hue settings for the remote camera, the querying of the current saturation settings of the remote camera, the setting of the saturation settings for the remote camera, and other camera control settings.

### BACKGROUND OF THE INVENTION

1. Field of the Invention

The present invention relates to remotely controlling a camera. In particular, the present invention relates to systems and methods for allowing any control point of a network to dynamically discover a remote camera control service and to selectively invoke actions to remotely control the camera.

2. Background and Related Art

Video surveillance and video communications (e.g. video conferencing) are technologies that are currently available to users. One particular application that falls under video communications is a video phone/entry camera that is typically installed at an entry location of a building or home. The video phone may be used to communicate with another video phone, such as one inside of the home. Alternatively, the video phone may be used to send video or images to a display device inside the home.

Thus, for example, a homeowner may have a video phone installed at the entrance (gate) to the house. When a visitor arrives at the entrance, the homeowner can have a video communication with the visitor.

While these techniques currently exist, challenges still exist with the technology. For example, the video phone is typically fixed and may not have the visitor at the entry door within the viewable frame. Accordingly, it would be an improvement in the art to augment or even replace current techniques with other techniques.

### SUMMARY OF THE INVENTION

The present invention relates to remotely controlling a camera. In particular, the present invention relates to systems and methods for allowing any control point of a network to dynamically discover a remote camera control service and to selectively invoke actions to remotely control the camera.

Implementation of the present invention takes place in association with a system that includes a camera or other video input device that is remotely controlled by the methods and processes of the present invention. In at least one implementation, a UPnP service for remote camera control is provided. Currently there is no UPnP service or device control protocol (DCP) that can provide remote control of a camera. The systems and methods of the present invention provide a standardized remote control of cameras.

Using an implementation of the present invention, any UPnP control point of a system can remotely control a camera to utilize the remote camera control service. Implementation of the present invention further allows for the querying of the current zoom settings of the remote camera, the setting of the zoom settings for the remote camera, the querying of the current pan settings of the remote camera, the setting of the pan settings for the remote camera, the querying of the tilt brightness settings of the remote camera, the setting of the tilt settings for the remote camera, the querying of the current brightness settings of the remote camera, the setting of the brightness settings for the remote camera, the querying of the current contrast settings of the remote camera, the setting of the contrast settings for the remote camera, the querying of the current hue settings of the remote camera, the setting of the hue settings for the remote camera, the querying of the current saturation settings of the remote camera, the setting of the saturation settings for the remote camera, and other camera control settings.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked configuration in accordance with an embodiment of the present invention;

FIG. 3 is a flow chart that provides representative processing in accordance with an embodiment of the present invention;

FIG. 4 illustrates a screen shot of a representative remote camera control service in accordance with the present invention;

FIG. 5 illustrates a UPnP remote camera control (RCC) device discovered by a control point on a network;

FIG. 6 illustrates a representative device description of the device retrieved in FIG. 5;

FIG. 7 illustrates a representative universal control point showing actions and state variables exposed by a remote camera control service;

FIG. 8 illustrates a representative manner for invoking of a SetTargetZoom action;

FIG. 9 illustrates a remote camera captured image after successfully invoking the SetTargetZoom action of FIG. 8;

FIG. 10 illustrates a representative manner for invoking of a SetTargetTilt action;

FIG. 11 illustrates a remote camera captured image after successfully invoking the SetTargetTilt action of FIG. 10;

FIG. 12 illustrates a representative manner for invoking of a SetTargetPan action;

FIG. 13 illustrates a remote camera captured image after successfully invoking the SetTargetPan action of FIG. 12;

FIG. 14 illustrates a representative manner for invoking of a SetTargetBrightness action;

FIG. 15 illustrates a remote camera captured image after successfully invoking the SetTargetBrightness action of FIG. 14;

FIG. 16 illustrates a representative manner for invoking of a SetTargetContrast action;

FIG. 17 illustrates a remote camera captured image after successfully invoking the SetTargetContrast action of FIG. 16;

FIG. 18 illustrates a representative manner for invoking of a SetTargetHue action;

FIG. 19 illustrates a remote camera captured image after successfully invoking the SetTargetHue action of FIG. 18;

FIG. 20 illustrates a representative manner for invoking of a SetTargetSaturation action; and

FIG. 21 illustrates a remote camera captured image after successfully invoking the SetTargetSaturation action of FIG. 20.

### DETAILED DESCRIPTION OF THE INVENTION

The present invention relates to remotely controlling a camera. In particular, the present invention relates to systems and methods for allowing any control point of a network to dynamically discover a remote camera control service and to selectively invoke actions to remotely control the camera.

Embodiments of the present invention take place in association with a system that includes a camera or other video input device that is remotely controlled by the methods and processes of the present invention. In at least one embodiment, a UPnP service for remote camera control is provided.

In one embodiment, any UPnP control point of a system may remotely control a camera to provide the remote camera control service. Further embodiments allows for the querying of the current zoom settings of the remote camera, the setting of the zoom settings for the remote camera, the querying of the current pan settings of the remote camera, the setting of the pan settings for the remote camera, the querying of the tilt brightness settings of the remote camera, the setting of the tilt settings for the remote camera, the querying of the current brightness settings of the remote camera, the setting of the brightness settings for the remote camera, the querying of the current contrast settings of the remote camera, the setting of the contrast settings for the remote camera, the querying of the current hue settings of the remote camera, the setting of the hue settings for the remote camera, the querying of the current saturation settings of the remote camera, the setting of the saturation settings for the remote camera, and other camera control settings, as will be further discussed below.

The following disclosure of the present invention is grouped into two subheadings, namely “Exemplary Operating Environment” and “Remote Camera Control.” The utilization of the subheadings is for convenience of the reader only and is not to be construed as limiting in any sense.

### Exemplary Operating Environment

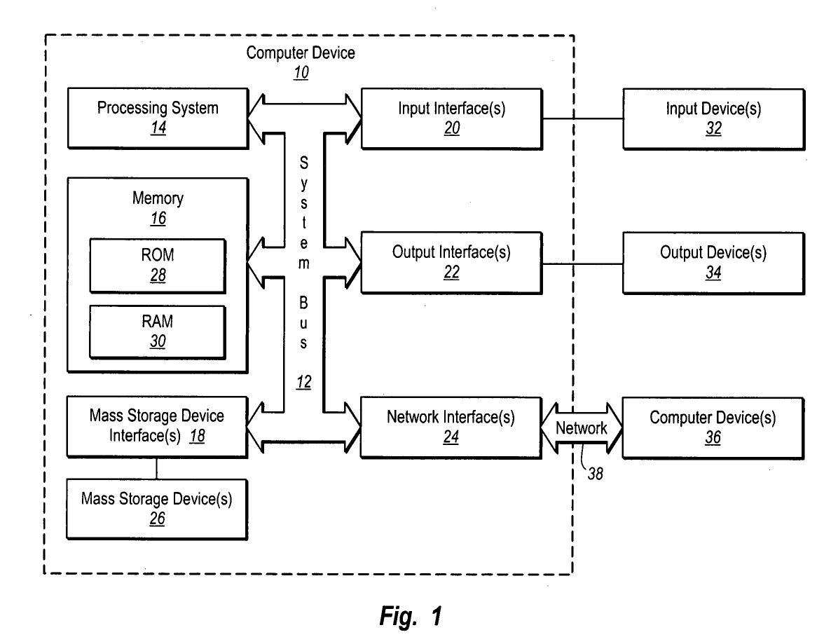

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

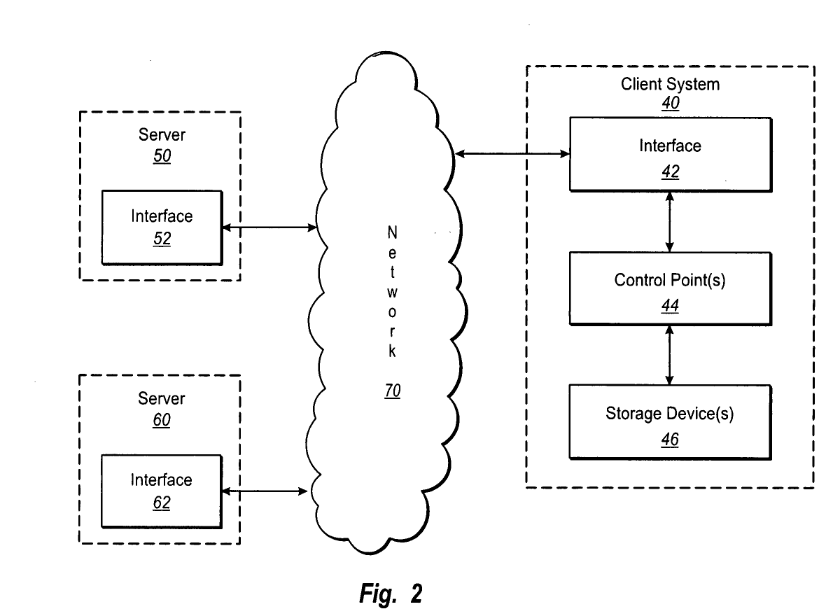

While those skilled in the art will appreciate that the invention may be practiced in networked computing environments with many types of system configurations, FIG. 2 represents an embodiment of the present invention that enables a server (e.g., a camera) to be remotely controlled on a network. In the illustrated embodiment, the term “server” is being used to reference a remote video input device (e.g., camera) and the term “client” to reference a computer device or control point, such as a home personal computer or other device. While FIG. 2 illustrates an embodiment that includes two servers connected to the network, alternative embodiments include one server connected to a network, or multiple servers connected to a network. Moreover, embodiments in accordance with the present invention also include a multitude of servers throughout the world connected to a network, where the network is a wide area network, such as the internet. In some embodiments, the network is a home network. In other embodiments, the network is a wireless network.

In FIG. 2, client system 40 represents a system configuration that includes an interface 42, one or more control points or computer devices (illustrated as control points 44 ), and a storage device 46. By way of example, client system 40 may be a single client or may be a conglomeration of computer devices that process and preserve high volumes of information.

Servers 50 and 60 are connected to server system via network 70, and respectively include interfaces 52 and 62 to enable communication. One of the servers, (e.g., server 50 ) is a camera or other device that is dynamically and remotely controlled, as will be further discussed below.

### Remote Camera Control

As provided above, embodiments of the present invention relate to remotely controlling a camera. In particular, the present invention relates to systems and methods for allowing any control point of a network to dynamically discover a remote camera control service and to selectively invoke actions to remotely control the camera.

Universal Plug and Play (UPnP) is an architecture for a pervasive peer-to-peer network connectivity of intelligent appliances and devices of all form factors. The UPnP basic device architecture may be used for discovery, description, control, eventing and presentation.

In accordance with at least some embodiments of the present invention, a UPnP Remote Camera Control (RCC) service is provided that allows a UPnP control point to dynamically discover and control a remote camera. Controlling a remote camera includes selectively invoking control actions. For example, in at least some embodiments, the following representative actions are selectively invoked to control the camera: (i) GetZoom; (ii) SetTargetZoom ; (iii) GetTilt; (iv) SetTargetTilt; (v) GetPan; (vi) SetTargetPan; (vii) GetBrightness; (viii) SetTargetBrightness; (ix) GetContrast; (x) SetTargetContrast; (xi) GetHue; (xii) SetTargetHue; (xiii) GetSaturation; and (xiv) SetTargetSaturation. Each of the representative actions will be individually discussed below.

GetZoom is an action that retrieves the current value of the zoom of the remote camera. A low value of zoom indicates zoom out, a high value indicates zoom in. The following table provides representative information relating to the GetZoom action:

| Argument | Direction | relatedStateVariable |
|---|---|---|
| newZoomOut | OUT | currentzoom |

SetTargetZoom is an action that sets the zoom of the remote camera. The new zoom value set is returned as OUT argument. A low value of zoom indicates zoom out, a high value indicates zoom in. If the IN argument is outside the allowed range of zoom values (e.g., vendor defined), then a value of −1 is returned as the OUT argument. For any other error, a value of −2 is returned as the OUT argument. The following table provides representative information relating to the SetTargetZoom action:

| Argument(s) | Direction | relatedStateVariable |
|---|---|---|
| newTargetValueZoom | IN | currentzoom |
| newTargetValueZoomOut | OUT | currentzoom |

GetTilt is an action that retrieves the current value of the tilt of the remote camera. A low value of tilt indicates camera tilted up, a high value indicates camera tilted down. The following table provides representative information relating to the GetTilt action:

| Argument | Direction | relatedStateVariable |
|---|---|---|
| newTiltOut | OUT | currenttilt |

SetTargetTilt is an action that sets the tilt of the remote camera. The new tilt value set is returned as an OUT argument. A low value of tilt indicates camera tilted up, a high value indicates camera tilted down. If the IN argument is outside the allowed range of tilt values (e.g., vendor defined), then a value of −1 is returned as an OUT argument. For any other error, a value of −2 is returned as an OUT argument. The following table provides representative information relating to the SetTargetTilt action:

| Arguments | Direction | relatedStateVariable |
|---|---|---|
| newTargetValueTilt | IN | currenttilt |
| newTargetValueTiltOut | OUT | currenttilt |

GetPan is an action that retrieves the current value of the pan of the remote camera. A low value of pan indicates camera panned to left, a high value indicates camera panned to right. The following table provides representative information relating to the GetPan action:

| Arguments | Direction | relatedStateVariable |
|---|---|---|
| newPanOut | OUT | currentpan |

SetTargetPan is an action that sets the pan of the remote camera. The new pan value set is returned as an OUT argument. A low value of pan indicates camera panned to left, a high value indicates camera panned to right. If the IN argument is outside the allowed range of pan values (e.g., vendor defined), then a value of −1 is returned as an OUT argument. For any other error, a value of −2 is returned as an OUT argument. The following table provides representative information relating to the SetTargetPan action:

| Argument(s) | Direction | relatedStateVariable |
|---|---|---|
| newTargetValuePan | IN | currentpan |
| newTargetValuePanOut | OUT | currentpan |

GetBrightness is an action that retrieves the current value of the brightness of the remote camera. The following table provides representative information relating to the GetBrightness action:

| Arguments | Direction | relatedStateVariable |
|---|---|---|
| newBrightnessOut | OUT | currentbrightness |

SetTargetBrightness is an action that sets the brightness of the remote camera. The new brightness value set is returned as an OUT argument. If the IN argument is outside the allowed range of brightness values (e.g., vendor defined), then a value of −1 is returned as an OUT argument. For any other error, a value of −2 is returned as an OUT argument. The following table provides representative information relating to the SetTargetBrightness action:

| Argument(s) | Direction | relatedStateVariable |
|---|---|---|
| newTargetValueBrightness | IN | currentbrightness |
| newTargetValueBrightnessOut | OUT | currentbrightness |

GetContrast is an action that retrieves the current value of the contrast of the remote camera. The following table provides representative information relating to the GetContrast action:

| Argument | Direction | relatedStateVariable |
|---|---|---|
| newContrastOut | OUT | currentcontrast |

SetTargetContrast is an action that sets the contrast of the remote camera. The new contrast value set is returned as an OUT argument. If the IN argument is outside the allowed range of contrast values (e.g., vendor defined), then a value of −1 is returned as an OUT argument. For any other error, a value of −2 is returned as an OUT argument. The following table provides representative information relating to the SetTargetContrast action:

| Argument(s) | Direction | relatedStateVariable |
|---|---|---|
| newTargetValueContrast | IN | currentcontrast |
| newTargetValueContrastOut | OUT | currentcontrast |

GetHue is an action retrieves the current value of the hue of the remote camera. The following table provides representative information relating to the GetHue action:

| Argument | Direction | relatedStateVariable |
|---|---|---|
| newHueOut | OUT | currenthue |

SetTargetHue is an action that sets the hue of the remote camera. The new hue value set is returned as an OUT argument. If the IN argument is outside the allowed range of hue values (e.g., vendor defined), then a value of −1 is returned as an OUT argument. For any other error, a value of −2 is returned as an OUT argument. The following table provides representative information relating to the SetTargetHue action:

| Argument(s) | Direction | relatedStateVariable |
|---|---|---|
| newTargetValueHue | IN | currenthue |
| newTargetValueHueOut | OUT | currenthue |

GetSaturation is an action that retrieves the current value of the Saturation of the remote camera. The following table provides representative information relating to the GetSaturation action:

| Arguments | Direction | relatedStateVariable |
|---|---|---|
| newSaturationOut | OUT | currentsaturation |

SetTargetSaturation is an action that sets the Saturation of the remote camera. The new saturation value set is returned as an OUT argument. If the IN argument is outside the allowed range of saturation values (e.g., vendor defined), then a value of −1 is returned as an OUT argument. For any other error, a value of −2 is returned as an OUT argument. The following table provides representative information relating to the SetTargetSaturation action:

| Arguments | Direction | relatedStateVariable |
|---|---|---|
| newTargetValueSaturation | IN | currentsaturation |
| newTargetValueSaturationOut | OUT | currentsaturation |

Accordingly, embodiments of the present invention embrace a variety of actions that may be selectively invoked to control a remote camera. The following table illustrates the state variables supported by the remote camera control (RCC) service for the actions discussed above.

| Variable Name | Required/Optional | Data Type | Allowed Value | Description |
|---|---|---|---|---|
| Currentbrightness | Optional | Ui4 | Min = Vendor Defined | Represents the |
| | | | Max = Vendor Defined | current brightness of |
| | | | Step = Vendor Defined | the remote camera |
| Currentcontrast | Optional | Ui4 | Min = Vendor Defined | Represents the |
| | | | Max = Vendor Defined | current contrast of the |
| | | | Step = Vendor Defined | remote camera |
| Currenthue | Optional | Ui4 | Min = Vendor Defined | Represents the |
| | | | Max = Vendor Defined | current hue of the |
| | | | Step = Vendor Defined | remote camera |
| Currentsaturation | Optional | Ui4 | Min = Vendor Defined | Represents the |
| | | | Max = Vendor Defined | current saturation of |
| | | | Step = Vendor Defined | the remote camera |
| Currentzoom | Optional | Ui4 | Min = Vendor Defined | Represents the |
| | | | Max = Vendor Defined | current zoom of the |
| | | | Step = Vendor Defined | remote camera |
| Currenttilt | Optional | Ui4 | Min = Vendor Defined | Represents the |
| | | | Max = Vendor Defined | current tilt of the |
| | | | Step = Vendor Defined | remote camera |
| currenpan | Optional | Ui4 | Min = Vendor Defined | Represents the |
| | | | Max = Vendor Defined | current pan of the |
| | | | Step = Vendor Defined | remote camera |

In accordance with at least some embodiments of the present invention, additional UPnP actions are available for remotely controlling the camera. For example, additional actions include: Querying current Automatic Gain (AGC) settings (TRUE/FALSE) of the remote camera; Setting Automatic Gain (AGC) (TRUE/FALSE) settings of the remote camera; Querying current Automatic White Balance settings (TRUE/FALSE) of the remote camera; Setting Automatic White Balance (TRUE/FALSE) settings of the remote camera; Querying current focus settings of the remote camera; Setting focus settings of the remote camera; Querying current video switcher setting for the remote camera; Setting the video switcher settings for the remote camera; Obtaining the current camera status (On/ Off), Changing the camera status (On/ Off), Other camera control settings; and the like.

The following provides a representative XML service description for remotely controlling a camera in accordance with a representative embodiment of the present invention. In particular, the following is representative code that provides a UPnP remote camera control service description in XML.

<?xml version = “1.0” ?>
_<scpd xmlns=”urn:schemas-upnp-org:service-1-0”>
\overline{_<}spec Version>
\overline{<maj}or>1</major>
<minor>0</minor>
</specVersion>
_<actionList>
\overline{_<a}ction>
\overline{<na}me>SetTargetTilt</name>
_<argumentList>
\overline{_<}argument>
\overline{<na}me>newTargetValueTilt</name>
<relatedStateVariable>currenttilt</relatedStateVariable>
<direction>in</direction>
</argument>
_<argument>
\overline{<na}me>newTargetValueTiltOut</name>
<relatedStateVariable>currenttilt</relatedStateVariable>
<direction>out</direction>
</argument>
</argumentList>
</action>
_<action>
\overline{<na}me>SetTargetPan</name>
_<argumentList>
\overline{_<}argument>
\overline{<na}me>newTargetValuePan</name>
<relatedStateVariable>currentpan</relatedStateVariable>
<direction>in</direction>
</argument>
_<argument>
\overline{<n}ame>newTargetValuePanOut</name>
<relatedStateVariable>currentpan</relatedStateVariable>
<direction>out</direction>
</argument>
</argumentList>
</action>
_<action>
\overline{<na}me>SetTargetZoom</name>
_<argumentList>
\overline{_<}argument>
\overline{<n}ame>newTargetValueZoom</name>
<relatedStateVariable>currentzoom</relatedStateVariable>
<direction>in</direction>
</argument>
_<argument>
\overline{<na}me>newTargetValueZoomOut</name>
<relatedStateVariable>currentzoom<relatedStateVariable>
<direction>out</direction>
</argument>
</argumentList>
</action>
_<action>
\overline{ }
<name>SetTargetBrightness</name>
_<argumentList>
\overline{ }
_<argument>
\overline{<n}ame>newTargetValueBrightness</name>
<relatedStateVariable>currentbrightness</relate
dStateVariable>
<direction>in</direction>
</argument>
_<argument>
\overline{<na}me>newTargetValueBrightnessOut</name>
<relatedStateVariable>currentbrightness</relate
dStateVariable>
<direction>out</direction>
</argument>
</argumentList>
</action>
_<action>
\overline{<n}ame>SetTargetContrast</name>
_<argumentList>
\overline{<n}ame>newTargetValueContrast</name>
<relatedStateVariable>currentcontrast</relatedStateVariable>
<direction>in</direction>
</argument>
_<argument>
\overline{<n}ame>newTargetValueContrastOut</name>
<relatedStateVariable>currentcontrast</relatedStateVariable>
<direction>out</direction>
</argument>
</argumentList>
</action>
_<action>
\overline{<n}ame>SetTargetHue</name>
_<argumentList>
\overline{_<}argument>
\overline{ }
<name>newTargetValueHue</name>
<relatedStateVariable>currenthue<relatedStateVariable>
<direction>in</direction>
</argument>
_<argument>
\overline{<n}ame>newTargetValueHueOut</name>
<relatedStateVariable>currenthue</relatedStateVariable>
<direction>out</direction>
</argument>
</argumentList>
</action>
_<action>
\overline{<n}ame>SetTargetSaturation</name>
_<argumentList>
\overline{_<}argument>
\overline{<n}ame>newTargetValueSaturation</name
<relatedStateVariable>currentsaturation</related
StateVariable>
<direction>in</direction>
</argument>
_<argument>
\overline{<n}ame>newTargetValueSaturationOut</name>
<relatedStateVariable>currentsaturation</related
StateVariable>
<direction>out</direction>
</argument>
</argumentList>
</action>
_<action>
\overline{<n}ame>GetZoom</name>
_<argumentList>
\overline{_<}argument>
\overline{<n}ame>newZoomOut</name>
<relatedStateVariable>currentzoom</relatedState
Variable>
<direction>out</direction>
<retval />
</argument>
</argumentList>
</action>
_<action>
\overline{<n}ame>GetTilt</name>
_<argumentList>
\overline{_<}argument>
\overline{<n}ame>newTiltOut</name>
<relatedStateVariable>currenttilt</relatedStateVariable>
<direction>out</direction>
<retval />
</argument>
</argumentList>
</action>
_<action>
\overline{<n}ame>GetPan</name>
_<argumentList>
\overline{_<}argument>
\overline{<n}ame>newPanOut</name>
<relatedStateVariable>currentpan</relatedStateVariable>
<direction>out</direction>
<retval />
</argument>
</argumentList>
</action>
_<action>
\overline{<n}ame>GetBrightness</name>
_<argumentList>
\overline{_<}argument>
\overline{<n}ame>newBrightnessOut</name>
<relatedStateVariable>currentbrightness</related
StateVariable>
<direction>out</direction>
<retval />
</argument>
</argumentList>
</action>
_<action>
\overline{<n}ame>GetContrast</name>
_<argumentList>
\overline{_<}argument>
\overline{<n}ame>newContrastOut</name>
<relatedStateVariable>currentcontrast</relatedStateVariable>
<direction>out</direction>
<retval />
</argument>
</argumentList>
</action>
_<action>
\overline{<n}ame>GetHue</name>
_<argumentList>
\overline{_<}argument>
\overline{<n}ame>newHueOut</name>
<relatedStateVariable>currenthue</relatedStateVariable>
<direction>out</direction>
<retval />
</argument>
</argumentList>
</action>
_<action>
\overline{<n}ame>GetSaturation</name>
_<argumentList>
\overline{_<}argument>
\overline{<n}ame>newSaturationOut</name>
<relatedStateVariable>currentsaturation</related
StateVariable>
<direction>out</direction>
<retval />
</argument>
</argumentList>
</action>
</actionList>
_<serviceStateTable>
\overline{_<}stateVariable sendEvents=”no”>
<name>currentzoom</name>
<dataType>int</dataType>
<defaultValue>0</defaultValue>
_<allowedValueRange>
\overline{<m}inimum>0</minimum
<maximum>100</maximum>
<step>1</step>
</allowedValueRange>
</stateVariable>
_<stateVariable sendEvents=”no”>
\overline{<n}ame>currenttilt</name>
<dataType>int</dataType>
<defaultValue>0</defaultValue>
_<allowedValueRange>
\overline{<m}inimum>0<minimum>
<maximum>100</maximum>
<step>1</step>
</allowedValueRange>
<stateVariable>
_<stateVariable sendEvents=”no”>
\overline{<n}ame>currentpan</name>
<dataType>int</dataType>
<defaultValue>0</defaultValue>
_<allowedValueRange>
\overline{<m}inimum>0</minimum>
<maximum>100</maximum>
<step>1<step>
</allowedValueRange>
</stateVariable>
_<stateVariable sendEvents=”no”>
\overline{<n}ame>currentbrightness</name>
<dataType>int<dataType>
<defaultValue>0</defaultValue>
_<allowedValueRange>
\overline{<m}inimum>0</minimum>
<maximum>100</maximum>
<step>1</step>
</allowedValueRange>
</stateVariable>
_<stateVariable sendEvents=”no”>
\overline{<n}ame>currentcontrast</name>
<dataType>int</dataType>
<defaultValue>0</defaultValue>
_<allowedValueRange>
\overline{<m}inimum>0</minimum>
<maximum>100</maximum>
<step>1</step>
</allowedValueRange>
</stateVariable>
_<stateVariable sendEvents=”no”>
\overline{<n}ame>currenthue</name>
<dataType>int</dataType>
<defaultValue>0</defaultValue>
_<allowedValueRange>
\overline{<m}inimum>0</minimum>
<maximum>100</maximum>
<step>1</step>
</allowedValueRange>
</stateVariable>
_<stateVariable sendEvents=”no”>
\overline{<n}ame>currentsaturation</name>
<dataType>int</dataType>
<defaultValue>0</defaultValue>
_<allowedValueRange>
\overline{<m}inimum>0</minimum>
<maximum>100</maximum>
<step>1</step>
<allowedValueRange>
<stateVariable>
</serviceStateTable>
</scpd>

Thus, the methods and processes of embodiments of the present invention allow for remotely controlling a video device, such as a camera. In at least some embodiments, UPnP implementations for utilizing an remote camera control (RCC) service and/or verification of interoperability of the remote control may be employed.

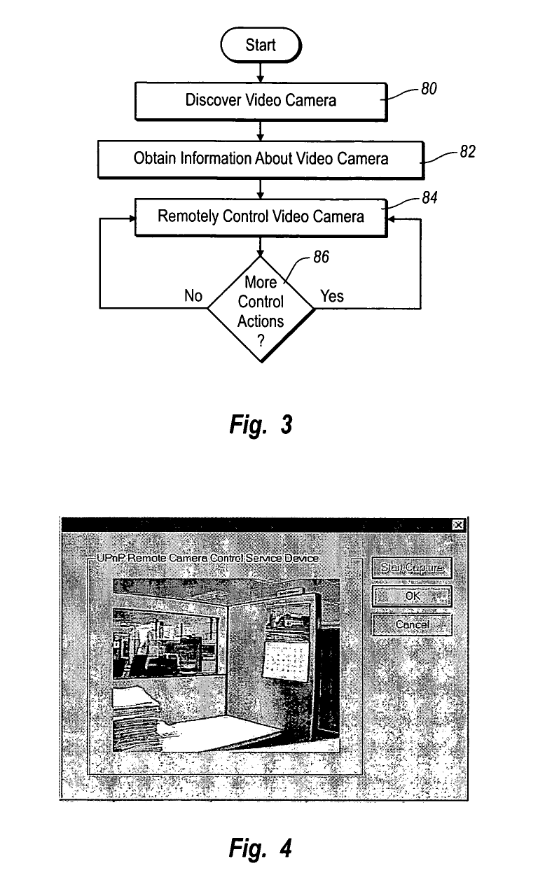

With reference now to FIG. 3, a flow chart is illustrated that provides representative processing in accordance with an embodiment of the present invention. In FIG. 3, execution begins at step 80, where a video camera or other video device is discovered by a computer device. In at least some embodiments, a UPnP protocol is utilized to discover the video phone. At step 82 information about the video camera is obtained. At step 84, the video camera is remotely controlled. A decision is made at decision block 86 as to whether more control actions should be invoked for remotely controlling the camera The following provides a representative example for remotely controlling a video device. In one embodiment, the remote camera control service is set up to capture a still image periodically and to save it to a directory on a web server. This allows the remote machine running an UPnP control point to remotely control the camera and then watch the webcam-remote camera captured image available from the web server.

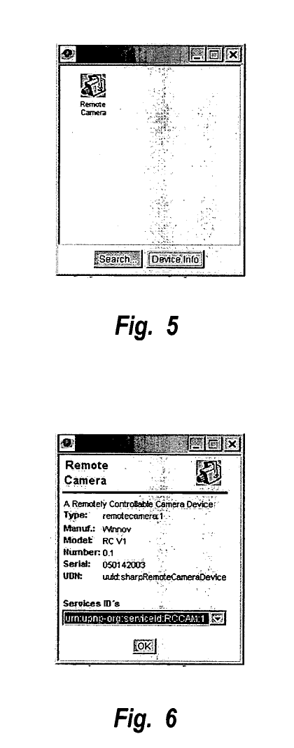

With reference now to FIG. 4, a screen shot of a representative remote camera control service is provided in accordance with an embodiment of the present invention. In FIG. 4, a video phone has been discovered and a video communication session has been established. The RCC service is running and the initial camera captured picture (with particular camera settings) is provided in FIG. 4. A variety of control points may be utilized to remotely control the camera. In the present embodiment, a UPnP control point is utilized to discover the RCC device and RCC service. FIG. 5 illustrates the UPnP remote camera control (RCC) device discovered by a control point on a network in accordance with the representative embodiment. FIG. 6 illustrates a representative device description of the device retrieved/discovered in FIG. 5.

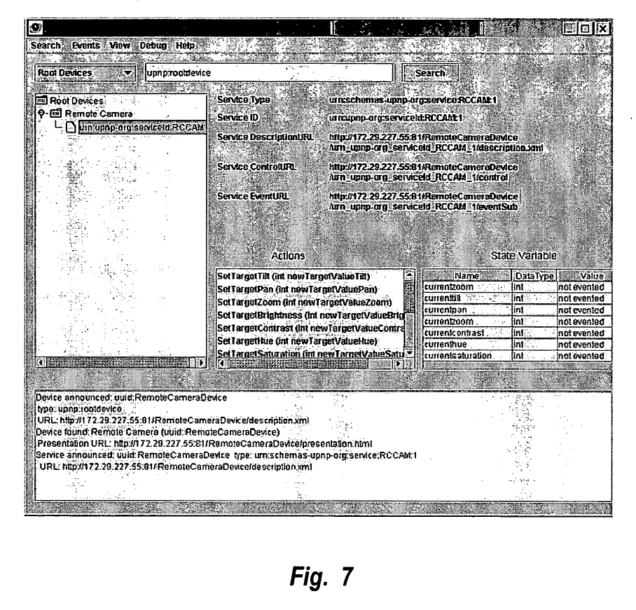

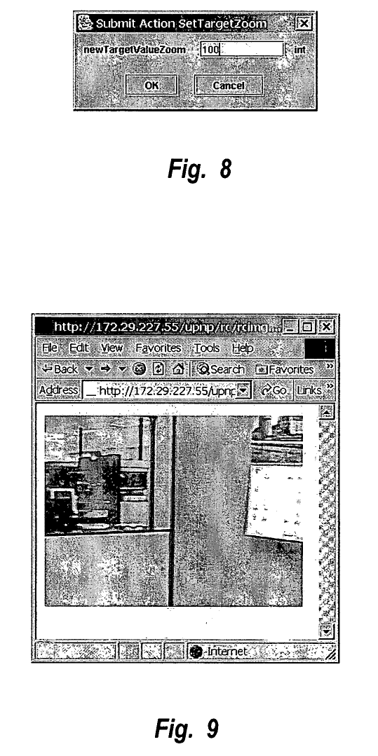

With reference now to FIG. 7, a representative universal control point showing actions and state variables exposed by a remote camera control is illustrated FIG. 8 illustrates a representative manner for invoking of a SetTargetZoom action. In particular, FIG. 8 illustrates a screen shot of invoking the SetTargetZoom action to remotely control the zoom of the camera using the RCC service. FIG. 9 illustrates a remote camera captured image after successfully invoking the SetTargetZoom action of FIG. 8.

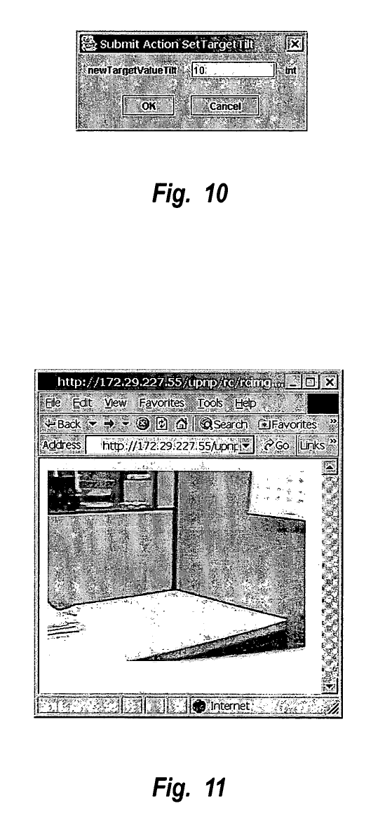

FIG. 10 illustrates a representative manner for invoking of a SetTargetTilt action. In particular, FIG. 10 illustrates a screen shot of invoking the SetTargetTilt action to remotely control the tilt of the camera using the RCC service. FIG. 11 illustrates a remote camera captured image after successfully invoking the SetTargetTilt action of FIG. 10.

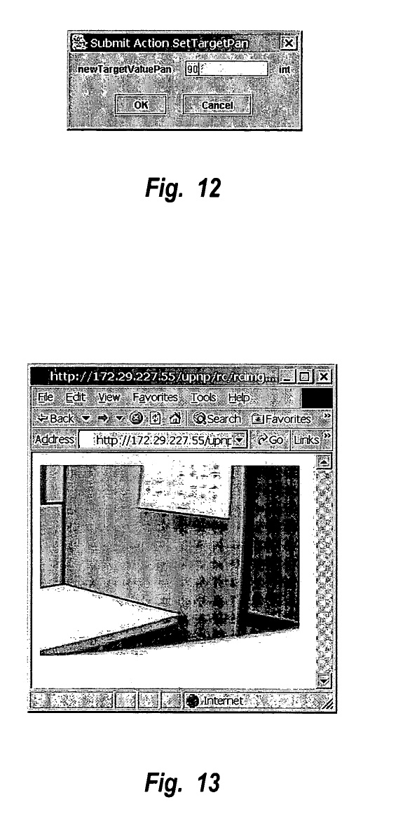

FIG. 12 illustrates a representative manner for invoking of a SetTargetPan action. In particular FIG. 12 provides a screen shot of invoking the SetTargetPan action to remotely control the pan of the camera using the RCC service. FIG. 13 illustrates a remote camera captured image after successfully invoking the SetTargetPan action of FIG. 12.

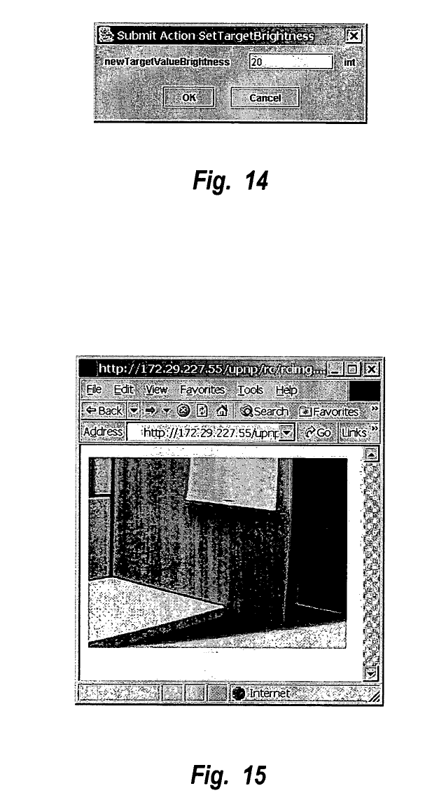

FIG. 14 illustrates a representative manner for invoking of a SetTargetBrightness action. In particular, FIG. 14 shows a screen shot of invoking the SetTargetBrightness action to remotely control the brightness of the camera using the RCC service. FIG. 15 illustrates a remote camera captured image after successfully invoking the SetTargetBrightness action of FIG. 14.

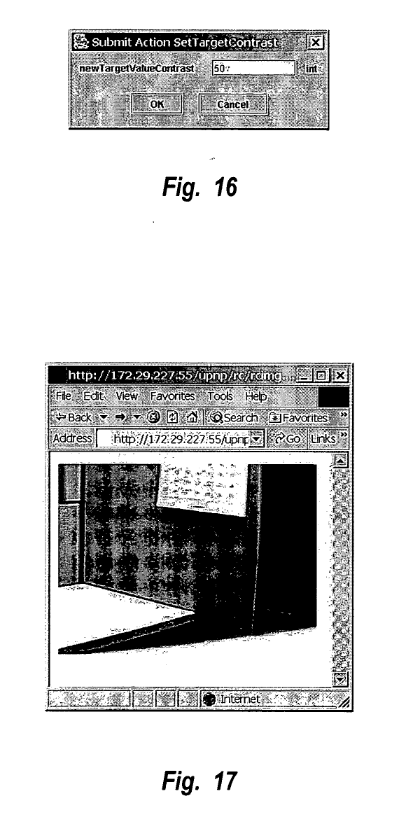

FIG. 16 illustrates a representative manner for invoking of a SetTargetContrast action. In particular, FIG. 16 shows a screen shot of invoking the SetTargetContrast action to remotely control the contrast of the camera using the RCC service. FIG. 17 illustrates a remote camera captured image after successfully invoking the SetTargetContrast action of FIG. 16.

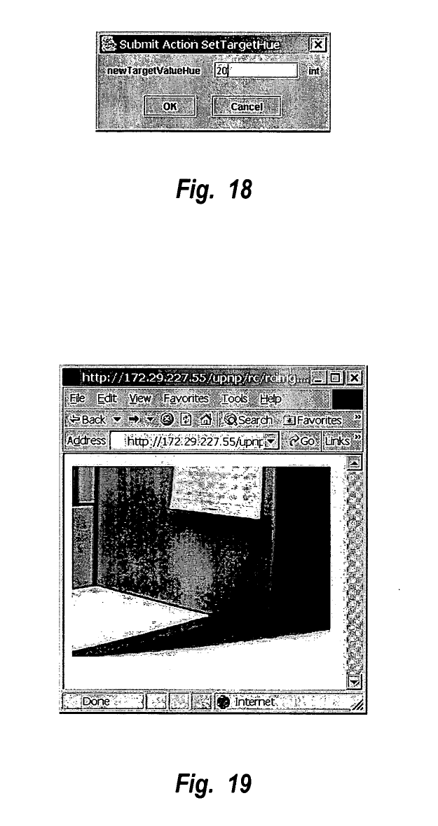

FIG. 18 illustrates a representative manner for invoking of a SetTargetHue action. In particular FIG. 18 shows a screen shot of invoking the SetTargetHue action to remotely control the hue of the camera using the RCC service. FIG. 19 illustrates a remote camera captured image after successfully invoking the SetTargetHue action of FIG. 18.

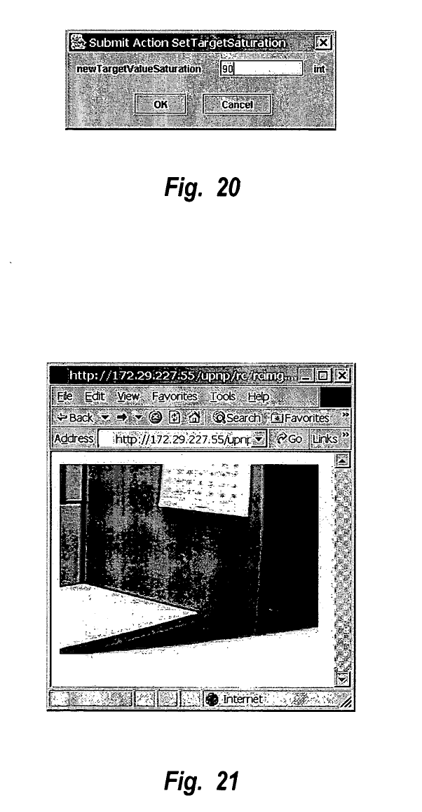

FIG. 20 illustrates a representative manner for invoking of a SetTargetSaturation action. In particular, FIG. 20 shows a screen shot of invoking the SetTargetSaturation action to remotely control the saturation of the camera using the RCC service. Before this action invocation, the SetTargetHue action was invoked to bring the remote camera image back to normal settings. FIG. 21 illustrates a remote camera captured image after successfully invoking the SetTargetSaturation action of FIG. 20.

At least some embodiments of the present invention embrace other user interfaces to control the remote camera. In some embodiments the user interface is provided on the control point to control the remote camera. For example, a slider user interface control is used in some embodiments to remotely control a camera.

Thus, as discussed herein, the embodiments of the present invention embrace remotely controlling a camera. In particular, the present invention relates to systems and methods for allowing any control point of a network to dynamically discover a remote camera control service and to selectively invoke actions to remotely control the camera.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method for remotely controlling the remote video input device, the method comprising:
using a control point to discover a remote video input device that is configured to provide a video service;
receiving a description of the video service that is provided by the remote video input device; and
remotely controlling an action of the video service.

2. A method as recited in claim 1, wherein step for using a control point to discover a remote video input device utilizes a UPnP protocol.

3. A method as recited in claim 2, wherein the step for receiving a description of the video service that is provided by the remote video input device further employs the UPnP protocol.

4. A method as recited in claim 1, wherein the control point comprises any control point of the system.

5. A method as recited in claim 1, wherein the action corresponds to a brightness setting of the remote video input device.

6. A method as recited in claim 5, wherein the action comprises at least one of:
(i) querying a current brightness setting of the remote video input device;
and
(ii) establishing a brightness setting for the remote video input device.

7. A method as recited in claim 1, wherein the action corresponds to a contrast setting of the remote video input device.

8. A method as recited in claim 7, wherein the action comprises at least one of:
(i) querying a current contrast setting of the remote video input device;
and
(ii) establishing a contrast setting for the remote video input device.

9. A method as recited in claim 1, wherein the action corresponds to a hue setting of the remote video input device.

10. A method as recited in claim 9, wherein the action comprises at least one of:
(i) querying a current hue setting of the remote video input device; and
(ii) establishing a hue setting for the remote video input device.

11. A method as recited in claim 1, wherein the action corresponds to a saturation setting of the remote video input device.

12. A method as recited in claim 11, wherein the action comprises at least one of:
(i) querying a current saturation setting of the remote video input device;
and
(ii) establishing a saturation setting for the remote video input device.

13. A method as recited in claim 1, wherein the action corresponds to a zoom setting of the remote video input device.

14. A method as recited in claim 13, wherein the action comprises at least one of:
(i) querying a current zoom setting of the remote video input device; and
(ii) establishing a zoom setting for the remote video input device.

15. A method as recited in claim 1, wherein the action corresponds to a pan setting of the remote video input device.

16. A method as recited in claim 15, wherein the action comprises at least one of:
(i) querying a current pan setting of the remote video input device; and
(ii) establishing a pan setting for the remote video input device.

17. A method as recited in claim 1, wherein the action corresponds to a tilt setting of the remote video input device.

18. A method as recited in claim 17, wherein the action comprises at least one of:
(i) querying a current tilt setting of the remote video input device; and
(ii) establishing a tilt setting for the remote video input device.

19. A method as recited in claim 1, wherein the action corresponds to a focus setting of the remote video input device.

20. A method as recited in claim 19, wherein the action comprises at least one of:
(i) querying a current focus setting of the remote video input device; and
(ii) establishing a focus setting for the remote video input device.

21. A method as recited in claim 1, wherein the action corresponds to a status setting of the remote video input device.

22. A method as recited in claim 21, wherein the action comprises at least one of:
(i) querying a current status setting of the remote video input device; and
(ii) establishing a status setting for the remote video input device.

23. A networked video system comprising:
a video device coupled to a network, wherein the video device is configured to selectively provide a video service; and
a remote control point coupled to the network, wherein the remote control point is configured to discover the remote video input device, receive a description of the video service that is provided by the remote video input device, and remotely control an action of the video service.

24. A system as recited in claim 23, wherein the remote control point uses a UPnP protocol to discover the remote video input device, receive a description of the video service that is provided by the remote video input device, and remotely control the action of the video service.

25. A system as recited in claim 23, wherein the control point is any control point of the system.

26. A system as recited in claim 23, wherein the action corresponds to at least one of:
(i) a zoom setting of the remote video input device;
(ii) a pan setting of the remote video input device;
(iii) a tilt setting of the remote video input device;
(iv) a focus setting of the remote video input device;
(v) a status setting of the remote video input device;
(vi) a brightness setting of the remote video input device;
(vii) a contrast setting of the remote video input device;
(viii) a hue setting of the remote video input device; and
(ix) a saturation setting of the remote video input device.

27. A system as recited in claim 26, wherein the action comprises at least one of:
(i) querying a current zoom setting of the remote video input device;
(ii) establishing a zoom setting for the remote video input device;
(iii) querying a current pan setting of the remote video input device;
(iv) establishing a pan setting for the remote video input device;
(v) querying a current tilt setting of the remote video input device;
(vi) establishing a tilt setting for the remote video input device;
(vii) querying a current focus setting of the remote video input device;
(viii) establishing a focus setting for the remote video input device;
(ix) querying a current status setting of the remote video input device;
(x) establishing a status setting for the remote video input device;
(xi) querying a current brightness setting of the remote video input device;
(xii) establishing a brightness setting for the remote video input device;
(xiii) querying a current contrast setting of the remote video input device;
(xiv) establishing a contrast setting for the remote video input device;
(xv) querying a current hue setting of the remote video input device;
(xvi) establishing a hue setting for the remote video input device;
(xvii) querying a current saturation setting of the remote video input device; and
(xviii) establishing a saturation setting for the remote video input device.

28. A computer program product for implementing within a computer system a method for remotely controlling a remote video input device, the computer program product comprising:
a computer readable medium for providing computer program code means utilized to implement the method, wherein the computer program code means is comprised of executable code for implementing the steps for:
using a control point to discover a remote video input device that is configured to provide a video service;
receiving a description of the video service that is provided by the remote video input device; and
remotely controlling an action of the video service.

29. A computer program product as recited in claim 28, wherein the step for using a control point to discover a remote video input device utilizes a UPnP protocol, and wherein the step for receiving a description of the video service that is provided by the remote video input device further employs the UPnP protocol.

30. A computer program product as recited in claim 28, wherein the action corresponds to at least one of:
(i) a zoom setting of the remote video input device;
(ii) a pan setting of the remote video input device;
(iii) a tilt setting of the remote video input device;
(iv) a focus setting of the remote video input device;
(v) a status setting of the remote video input device;
(vi) a brightness setting of the remote video input device;
(vii) a contrast setting of the remote video input device;
(viii) a hue setting of the remote video input device; and
(ix) a saturation setting of the remote video input device.

31. A computer program product as recited in claim 30, wherein the action is one of:
(i) querying a current zoom setting of the remote video input device;
(ii) establishing a zoom setting for the remote video input device;
(iii) querying a current pan setting of the remote video input device;
(iv) establishing a pan setting for the remote video input device;
(v) querying a current tilt setting of the remote video input device;
(vi) establishing a tilt setting for the remote video input device;
(vii) querying a current focus setting of the remote video input device;
(viii) establishing a focus setting for the remote video input device;
(ix) querying a current status setting of the remote video input device;
(x) establishing a status setting for the remote video input device;
(xi) querying a current brightness setting of the remote video input device;
(xii) establishing a brightness setting for the remote video input device;
(xiii) querying a current contrast setting of the remote video input device;
(xiv) establishing a contrast setting for the remote video input device;
(xv) querying a current hue setting of the remote video input device;
(xvi) establishing a hue setting for the remote video input device;
(xvii) querying a current saturation setting of the remote video input device; and
(xviii) establishing a saturation setting for the remote video input device.
